(19) United States
(12) Patent Application Publication
(10) Pub. No.: US 2023/0044048 A1
(43) Pub. Date: Feb. 9, 2023

(54) NATURAL LANGUAGE PROCESSING COMPREHENSION AND RESPONSE SYSTEM AND METHODS

(71) Applicant: ROSOKA SOFTWARE, INC., Herndon, VA (US)

(72) Inventors: Gregory F. ROBERTS, Herndon, VA (US); Michael Allen SORAH, Herndon, VA (US)

(21) Appl. No.: 17/785,040

(22) PCT Filed: Aug. 14, 2020
(86) PCT No.: PCT/US2020/046372

§ 371 Date: Jun. 13, 2022

Related U.S. Application Data
(60) Provisional application No. 62/888,387, filed on Aug. 16, 2019.

(51) Int. Cl. G06F 40/35; G06F 40/279; G06F 40/247; G06F 16/332; G06F 16/31

(52) U.S. Cl. CPC G06F 40/35; G06F 16/31; G06F 16/3329; G06F 40/247; G06F 40/279

(57) ABSTRACT

An automatic, system-generated, multi-faceted comprehension and response capability, using Natural Language Processing, to provide value specific answers from available unstructured data, documents and text. Questions and queries are interpreted by the system's capability to determine the type of questions and provide a response or answer based on the data or information available. If the answer is in the ingested data, a response is provided that is either; a list of documents, a list of document snippets with the answer contained in the snippets, a formalized and templated response, or a highly relevant hand curated response.

### CROSS-REFERENCE TO RELATED APPLICATION

This application is a national phase filing under 35 U.S.C. § 371 of International Application No. PCT/US2020/046372, filed Aug. 14, 2020, which claims the benefit of U.S. Provisional Application No. 62/888,387 filed Aug. 16, 2019. The entire content of the above-referenced application is hereby incorporated by reference.

### FIELD

Some exemplary embodiments may generally relate to natural language processing, and specifically to the capabilities of a natural language processing system to comprehend and respond to inquiries.

### BACKGROUND

In the modern world in which exponential growth of unstructured data includes documents, emails, and internet pages, there is a need to systematically extract only value specific information from the volumes of available data. Conventionally, the amount of time and effort involved with exacting value specific information from the volumes of available information has been a problem.

Previous solutions have taken the stance that all information has an equal value when processed, stored, and retrieved, and that categorized information would also have equal value when processed stored and retrieved. Information within the documents is understood to be static and unchanging over time. However, the specific value or importance of the information within the documents is better determined at the time when an answer or response is needed, rather than when the document was first retrieved, stored or saved. The following two sentences provide an illustrative example, “Juju Bean owns a 35 mm gun which she keeps in her KIA” and “Juju was seen in the Paris Hilton.” Each of the two sentences may have equal value to similar information when obtained. However, an investigator attempting to identify who committed a crime at a specific hotel using a specific gun may now place a higher value on these.

Limitations exist from previous methods of categorizing data at the time of receipt or initial processing. Using the example noted above, Juju Bean may or may not have been classified as a person, and Paris Hilton may have been classified as a person instead of being classified as a location or hotel. The limitations also present problems with developing responses to queries.

### SUMMARY

In accordance with some embodiments, a method may include receiving a document at a natural language processing engine. The natural language processing engine extracts text from the document. The method may further include indexing the extracted text at a data store. The method may further include mapping a query to an index query to retrieve a response set stored in the natural language processing engine. The method may further include mapping the response set to the query, wherein the response is based on the query.

In accordance with some embodiments, an apparatus may include at least one processor and at least one memory including computer program code. The at least one memory and the computer program code may be configured to, with the at least one processor, cause the apparatus to perform at least receiving a document at a natural language processing engine. The natural language processing engine extracts text from the document. The at least one memory and the computer program code may be further configured to, with the at least one processor, cause the apparatus to perform at least indexing the extracted text at a data store. The at least one memory and the computer program code may be further configured to, with the at least one processor, cause the apparatus to perform at least mapping a query to an index query to retrieve a response set stored in the natural language processing engine. The at least one memory and the computer program code may be further configured to, with the at least one processor, cause the apparatus to at perform least mapping the response set to the query, wherein the response is based on the query.

In accordance with some embodiments, an apparatus may include means for receiving a document at a natural language processing engine. The natural language processing engine extracts text from the document. The apparatus may further include means for indexing the extracted text at a data store. The apparatus may further include means for mapping a query to an index query to retrieve a response set stored in the natural language processing engine. The apparatus may further include means for mapping the response set to the query, wherein the response is based on the query.

In accordance with some embodiments, a non-transitory computer readable medium may be encoded with instructions that may, when executed in hardware, perform a method. The method may include receiving a document at a natural language processing engine. The natural language processing engine extracts text from the document. The method may further include indexing the extracted text at a data store. The method may further include mapping a query to an index query to retrieve a response set stored in the natural language processing engine. The method may further include mapping the response set to the query, wherein the response is based on the query.

In accordance with some embodiments, an apparatus may include circuitry configured to perform receiving a document at a natural language processing engine. The natural language processing engine extracts text from the document. The circuitry may be further configured to perform indexing the extracted text at a data store. The circuitry may be further configured to perform mapping a query to an index query to retrieve a response set stored in the natural language processing engine. The circuitry may be further configured to perform mapping the response set to the query, wherein the response is based on the query.

### BRIEF DESCRIPTION OF THE DRAWINGS

For proper understanding of example embodiments, reference should be made to the accompanying drawings, wherein:

FIG. 1 illustrates an example flow diagram, according to an embodiment;

FIG. 2 illustrates an example flow diagram, according to an embodiment;

FIG. 3 illustrates an example flow diagram, according to an embodiment.

FIG. 4 illustrates an example flow diagram, according to an embodiment.

FIGS. 5a-f illustrate an example result capability based on dynamic categorization, according to an embodiment.

### DETAILED DESCRIPTION

While many systems may interpret queries, these systems provide results in the form of an excerpt from a document in a reconfigured sentence. Certain embodiments may use the Rosoka Natural Language Processing (NLP) multilingual extraction engine although other NLP engines may be used. Certain embodiments use the NLP Comprehension and Response capability to provide a solution to the problems discussed above. The NLP may return a response in one of four distinct methods that is dependent on the type of query or question that a user presents. The response methods are: standard keyword query, hand curated Q/A pairs, NLP answers, and snippet answers.

The standard keyword query is similar to the type of query a person may type into an Internet Web service search engine, such as Google. For example, one may type a typical keyword or series of keywords, like “lipton” and they are returned a list of document snippets. This functionality of certain embodiments is consistent with most modern search engine platform.

The hand curated Question/Answer (Q/A) pair enables an administrator to match answers to questions. This capability of certain embodiments provides the administrator an opportunity to provide a corporately consistent answer that will be returned to a user on a specific question. When a question is being asked, an example embodiment first checks to see if that question has a hand curated answer. If so, the hand curated answer is returned to the user. If not, the example embodiment moves on to search for NLP Answers.

The NLP Answers are answers that are automatically generated from certain templated questions, if the question being asked is understood, and there is no curated answer for it. These templated answers look for a corresponding Predicate-Subject-Object (PSO) relationship from within the output. Certain embodiments may use NLP Answers algorithm, which use the PSO and automatically generate a formulaic response. For example, questions like, “What is PERSON's birthday?” will generate an answer in the form of “PERSON's birthday is DATE” from the appropriate PSO that has the PERSON as the Subject, the DATE as the Object and the Predicate indicates a “birthday” relationship.

The Snippet Answers are returned if a question is recognized, but there is not an available curated answer. An example embodiment may look for the likely answer that is contained within the snippets. If there is a likely answer, that snippet is returned to the user.

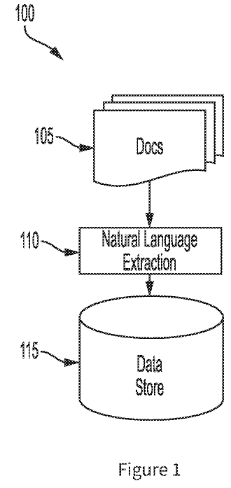

FIG. 1 illustrates an example flow diagram 100 for the NLP comprehension and response capability, according to an embodiment. To make documents searchable, documents 105 are first processed by a Natural Language Processing engine 110 to extract the text, "gloss" (English meaning of the text), list of entities of interest, (PEOPLE, PLACES, ORGANIZATIONS, DRUGS, WEAPONS, etc.) relationships between entities as a predicate-subject-object (PSO) triple, along with a pointer back to the source document. These extracted results are then stored in a data store 115 search engine and indexed (e.g, a relational database management system (RDBMS) or NoSQL data store) where they can be queried against and retrieved, as shown in FIG. 1.

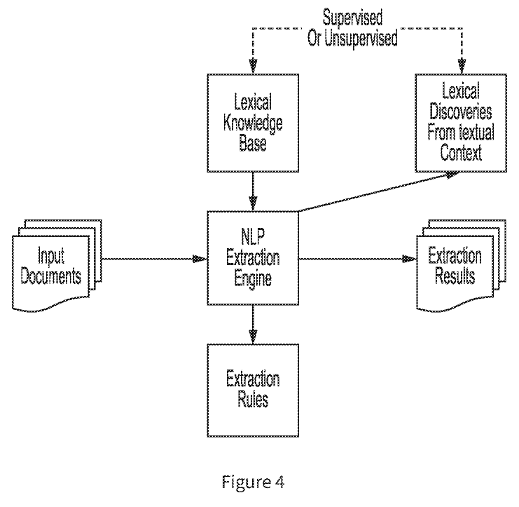

FIG. 4 illustrates a Natural Language Processing extraction engine, which receives input documents, extraction rules, and lexical knowledge. The Natural Language Processing extraction engine outputs extraction results and lexical discoveries from textual context. A person of ordinary skill in the art would understand that standard NLP capable of extracting the relationships between two entities as a predicate may be used in certain embodiments. Other NLP engines that extract the form of a predicated, subject, and object may also be used, according to certain embodiments. Although several NLP engines that extract relationships could be used, there are some conventional NLP engines that only identify entities, or entities and co-occurrences in a document or paragraph may require further modifications to practice certain embodiments.

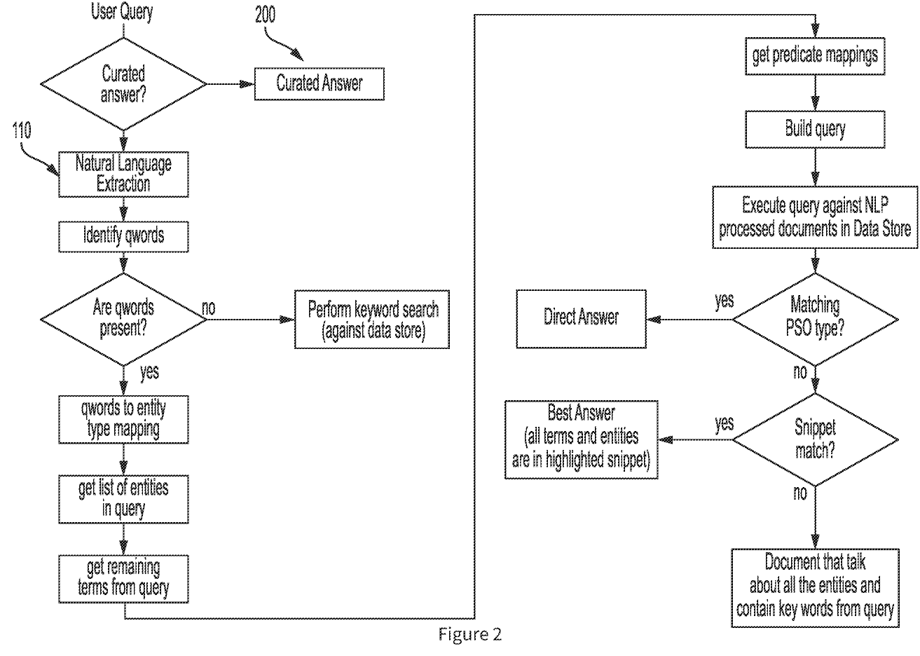

FIG. 2 illustrates an example flow diagram 200 for the NLP comprehension and response capability, according to an embodiment. A user submits a user query either in the form of a set of key words or in the form of a natural language query in the form of a question or qwords (e.g., who, what, where, and when). The user query is mapped to an index query that the data store understands (i.e. an SQL query for RDMS, or a json or xquery for NoSQL data stores) to retrieve a response set in which the response set is the stored NLP extracted metadata from the document and was saved in a data store 115. The response set is then mapped to form the users response based on the question type that was asked.

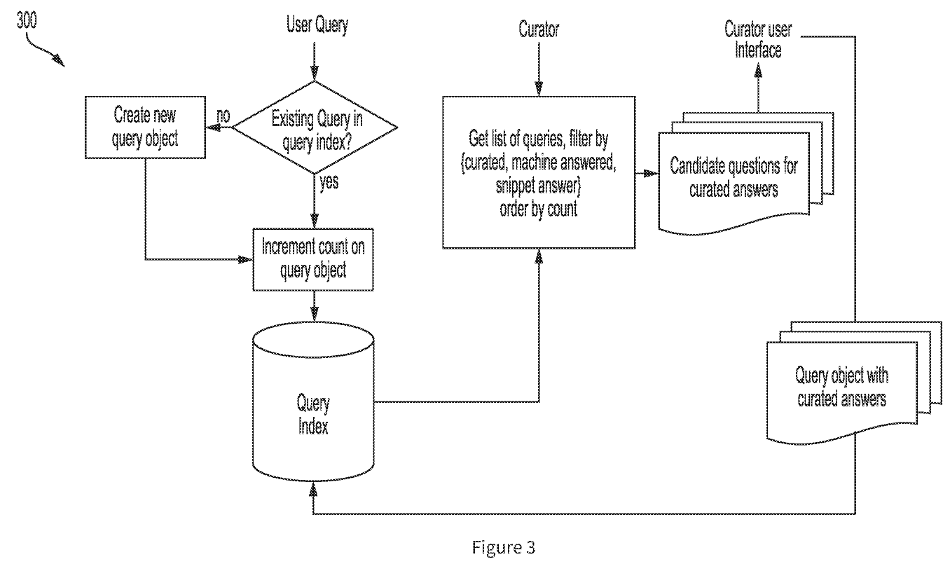

FIG. 3 illustrates an example flow diagram 300 for the NLP comprehension and response capability, according to an embodiment. According to certain embodiments, questions and queries are automatically interpreted by the capability to understand the type of questions. If the answer to the question is in the ingested data, a response is provided that is either a list of documents, a list of document snippets with the answer contained in the snippet, a formalized and templated response, or a highly relevant, hand curated response. The process for providing the query response is shown in FIG. 3.

As illustrated in FIG. 3, when a user asks a query, certain embodiments first perform a check to determine if the query has been asked before by checking an index for a match to the query string. If the query is not present in the query index, a query object is created and the counter for that object is set to 1. If the query object is already in the index, then the counter for that query is incremented. If the query has a “curated” answer, then that answer is returned to the user. As an out of band process a curator may get the list of queries that are sorted by the count of the number of times the query has been asked. The queries can be filtered as to whether or not there is a curated answer, a system generated answer, a snippet answer, or a keyword answer. The curator can then supply a “curated” answer to the question as a vetted corporate response. Additionally the “curator” may attach links to the answer for further reading about or related to the specific question. For example, if a user asked a question like, “When was close-up launched?” the user may get back a hand curated answer, along with the list of snippets and the appropriate dossiers attached to the answer. In certain embodiments a result with high value answer to questions for specific knowledge retention and information standardization may be returned.

If there is no curated response, or in certain embodiments in addition to providing a curated response, the query is processed by a Natural Language engine for extraction to get a list of “qwords”, entities, and terms present in the query. “Qwords” are interrogative or question words such as who, what, where, when, etc...

If there are no “qwords” present, then query is assumed to be a “Key Word” search. A key word search is performed against the text index and gloss so that the user is presented with the matching “snippet” or highlighted text sample where the matching terms were found in the document along with the link to retrieve the document.

If there are “qwords” in the query, then a lookup may be performed to get the set of entity types that must be present in the document to be able to answer that type of question. For example, the question “Who is John Galt?” must have an entity of type “PERSON” or “ORGANIZATION.” Similarly, the question “When was John Galt born?” must have a PERSON or ORGANIZATION along with a TIMESTAMP entity present in the index response to be a possible answer.

Specific entity values that are in the user query are added as the index query requiring that the response includes not only the required entity types, but also includes the specific entity that was in the user’s query.

The remaining terms (and their synonyms) in the user’s query are used as a key word constraint in the index query, as well as a “should match” on the predicates on the PSO triplates.

The final index query may be built by populating a query template with the Entity Types, specific entities that must match, the key word list that should be present, and predicate should match.

A return set is then evaluated to see if there are matching PSO triplets that have the required PSO patterns in them, and the PSO has the required matching entities. For example, for the question “When was John Galt born?” the PSO pattern must be PERSON to TIMESTAMP, predicate type=“born_on.” That pattern is then mapped into a human readable “Direct Answer” format: “John Galt was born on May 2, 1779.”

If the PSO pattern, entity, and predicate condition was not matched, then the response given to the user will be the set of document snippets that contains the explicit entity and terms, and the response is returned as a “Best Answer” as there was no source basis in the index to answer the question that was asked. For example, a paragraph (a snippet) talking about the birth of his children would give an indication of John Galt’s age. If there still is no snippet match, then the snippets set returned to the user is the index return set that best matches the entities and terms, in essence a keyword return set.

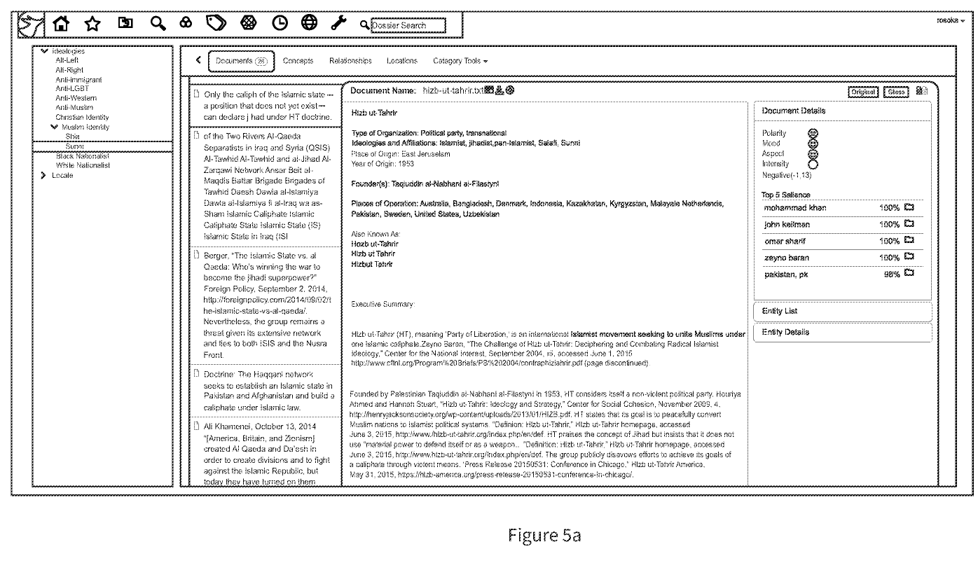

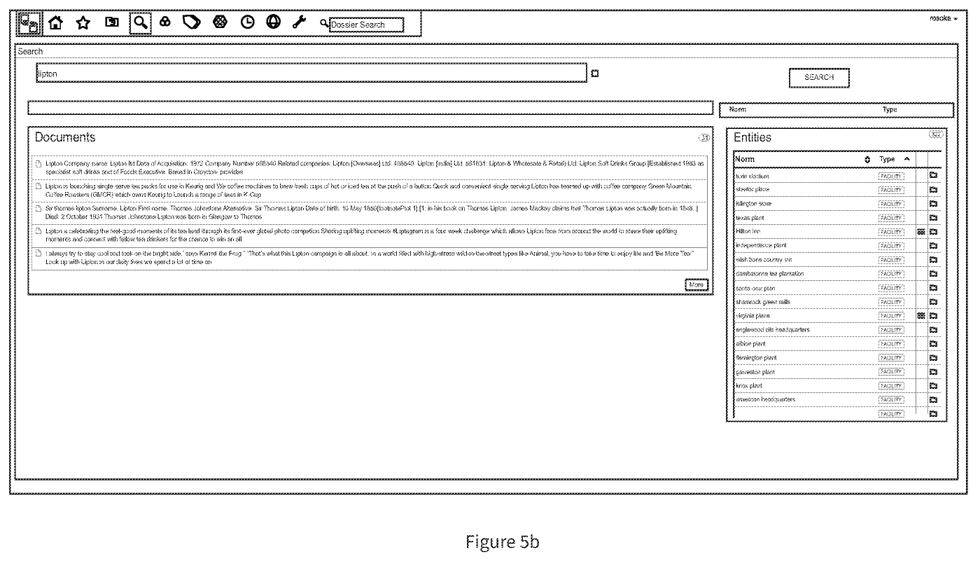

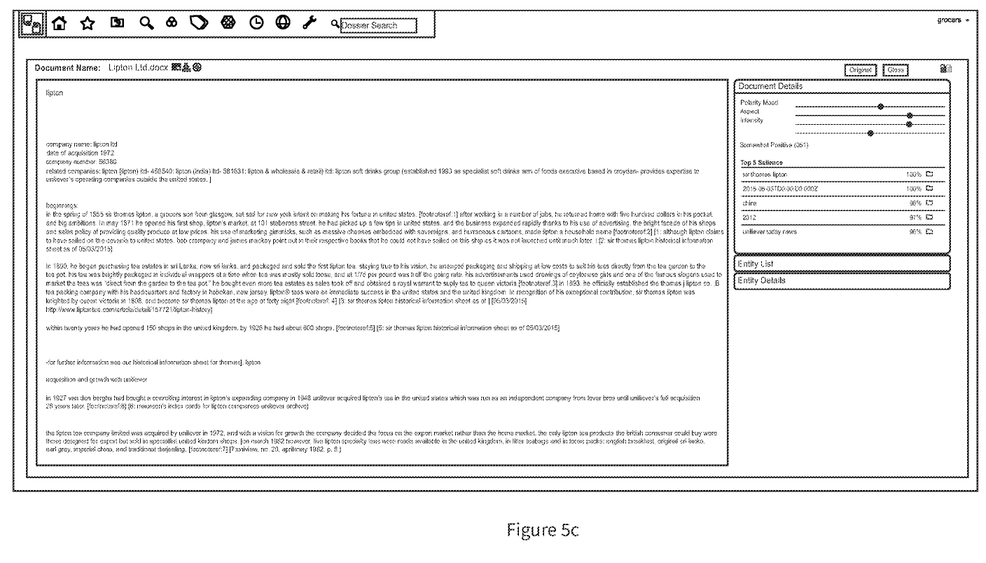

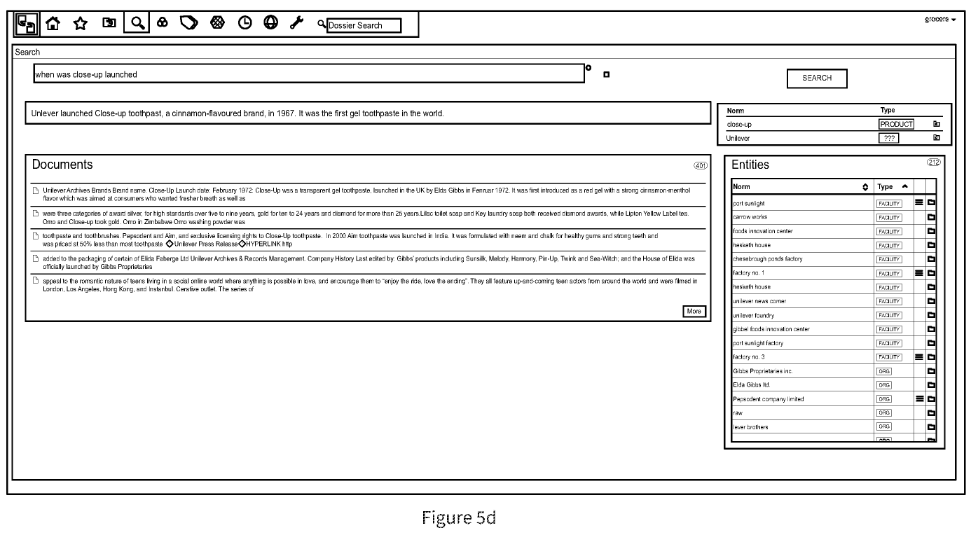

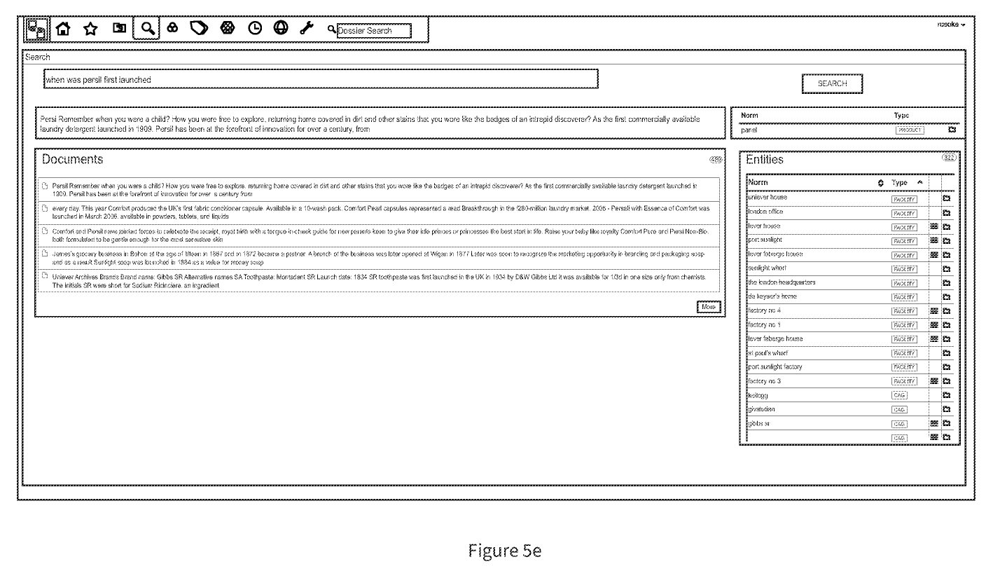

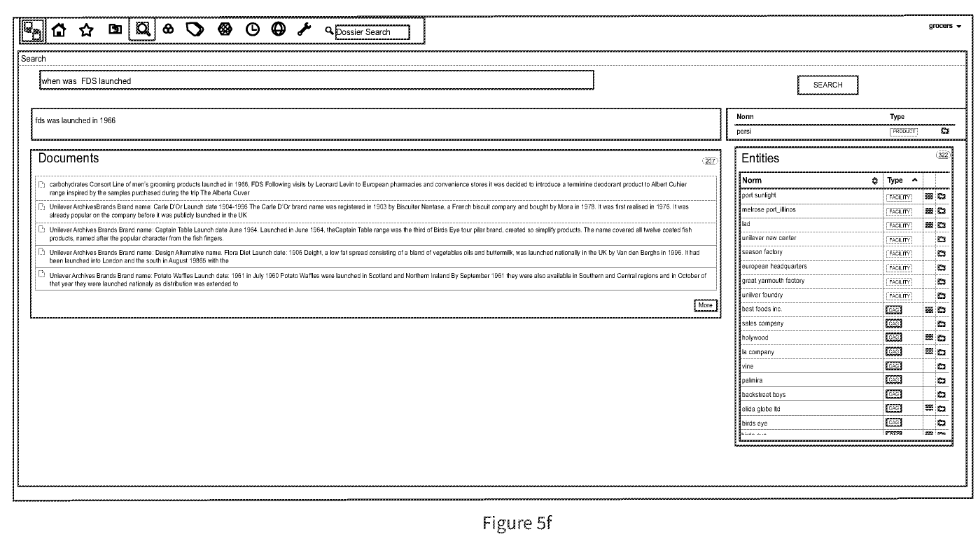

FIGS. 5a-5f illustrate an example result capability based on dynamic categorization. FIG. 5a illustrates that categories may be immediately available for query once a category has been created. In particular, FIG. 5a shows the documents that comprise the category of “Sunni” that was made immediately available for query. FIG. 5a illustrates that the Natural Language Processing Question/Answer capability can return response in one of four distinct methods, depending on the type of query or question that a user asks. The four distinct methods may include standard keyword query, hand curated Q/A pairs, snippet answers, and NLP Answers.

As discussed above, standard keyword query is the type of query used with a search engine. FIG. 5b illustrates a query based on a typical keyword query. Specifically, FIG. 5b shows the results from a query of “lipton.” The user can select a snippet and the user may be taken to a document viewer, as shown in FIG. 5c. The document viewer of FIG. 5c shows a document view that may also include entity extraction highlights and metadata about individual entities and the document as a whole.

Hand curated Q/A pairs enable an archivist to match answers to questions. In some instances hand curated Q/A pairs would be high volume questions that users would likely ask the archivist. This allows a consistent answer to the user. In certain embodiments, when the question is understood, the NLP may look to see if it is a question that has a hand curated answer. FIG. 5d illustrates an example of a user asking a question like, “when was close-up launched?” The user may get back a hand curated answer, along with the list of snippets and the appropriate dossiers attached to the answer, as shown in the top right portion of FIG. 5d. By selecting one of the dossiers, the user may be taken to that dossier page.

A snippet answer is something is returned when a question is recognized, but there is not an available curated answer. For example, FIG. 5e illustrates if a user were to ask a question like, “when was persil first launched?” Certain embodiments may return the best snippets that answer the question, along with the most likely dossier attached to the answer, as shown in the top right of FIG. 5e. These answers to novel questions or questions that the curators haven't yet created a hand curated answer pair.

NLP answers are actual answers that are automatically generated when a question being asked is understood and there is no curated answer for it. FIG. 5f illustrates an example when a user asks a question like, “when was FDS launched?” Certain embodiments may return an answer that matches the appropriate PSO in the data, along with the PSO formatted into a more readable form and the dossier(s) attached to the answer, as shown in the top right of FIG. 5f.

Certain embodiments are directed to an apparatus including at least one processor and at least one memory. The memory may include computer program code. The at least one memory and computer program code may be configured, with the at least one processor, to cause the apparatus at least to perform a method.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1. A method, comprising:
receiving a document at a natural language processing engine, wherein the natural language processing engine extracts text from the document;
indexing the extracted text at a data store;
mapping a query to an index query to retrieve a response set stored in the natural language processing engine; and
mapping the response set to the query, wherein the response is based on the query.

2. The method according to claim 1, further comprising:
determining when the query has a curated answer; and
providing the curated answer, when the query has a curated answer.

3. The method according to claims 1 or 2, further comprising:
determining when the query includes qwords;
extracting the qwords by the natural language processing engine, when the query includes qwords; and
determining entity types that must be present in the document based on the qwords.

4. The method according to any of claims 1-3, wherein the natural processing engine identifies remaining terms in the query and synonyms of the remaining terms are used as a key word constraint in the index query.

5. The method according to any of claims 1-4, wherein the natural processing engine identifies remaining terms in the query and synonyms of the remaining terms are used as a should match term on a predicate-subject-object triplate.

6. The method according to any of claims 1-5, wherein the extracted text from the natural language processing engine is used as consideration for the documents inclusion into or exclusion from a category.

7. The method according to any of claims 1-6, further comprising:
returning a set of documents snippets, wherein the snippets comprise an explicit entity and terms.

8. The method of claim 7, wherein the return set is evaluated based on matching predicate-subject-object triplet entities.

9. The method according to claims 7 or 8, wherein the snippets comprise a set of documents that best match the entities and terms based on a keyword.

10. An apparatus, comprising:
at least one processor; and
at least one memory comprising computer program code;
the at least one memory and computer program code configured to, with the
at least one processor, to cause the apparatus at least to perform
receiving a document at a natural language processing engine, wherein the natural language processing engine extracts text from the document;
indexing the extracted text at a data store;
mapping a query to an index query to retrieve a response set stored in the natural language processing engine; and
mapping the response set to the query, wherein the response is based on the query.

11. The apparatus according to claim 10, wherein the at least one memory and computer program code are further configured to perform:
determining when the query has a curated answer; and
providing the curated answer, when the query has a curated answer.

12. The apparatus according to claims 10 or 11, wherein the at least one memory and computer program code are further configured to perform:
determining when the query includes qwords;
extracting the qwords by the natural language processing engine, when the query includes qwords; and
determining entity types that must be present in the document based on the qwords.

13. The apparatus according to any of claims 10-12, wherein the natural processing engine identifies remaining terms in the query and synonyms of the remaining terms are used as a key word constraint in the index query.

14. The apparatus according to any of claims 10-13, wherein the natural processing engine identifies remaining terms in the query and synonyms of the remaining terms are used as a should match term on a predicate-subject-object triplate.

15. The apparatus according to any of claims 10-14, wherein the extracted text from the natural language processing engine is used as consideration for the documents inclusion into or exclusion from a category.

16. The apparatus according to any of claims 10-15, wherein the at least one memory and computer program code are further configured to perform:
returning a set of documents snippets, wherein the snippets comprise an explicit entity and terms.

17. The apparatus according to claim 16, wherein the return set is evaluated based on matching predicate-subject-object triplet entities.

18. The apparatus according to claims 16 or 17, wherein the snippets comprise a set of documents that best match the entities and terms based on a keyword.

19. An apparatus, comprising:
circuitry configured to perform
receiving a document at a natural language processing engine, wherein the natural language processing engine extracts text from the document;
indexing the extracted text at a data store;
mapping a query to an index query to retrieve a response set stored in the natural language processing engine; and
mapping the response set to the query, wherein the response is based on the query.

20. The apparatus according to claim 19, wherein the circuitry is further configured to perform:
determining when the query has a curated answer; and
providing the curated answer, when the query has a curated answer.

21. The apparatus according to claims 19 or 20, wherein the circuitry is further configured to perform:
determining when the query includes qwords;
extracting the qwords by the natural language processing engine, when the query includes qwords; and
determining entity types that must be present in the document based on the qwords.

22. The apparatus according to any of claims 19-21, wherein the natural processing engine identifies remaining terms in the query and synonyms of the remaining terms are used as a key word constraint in the index query.

23. The apparatus according to any of claims 19-22, wherein the natural processing engine identifies remaining terms in the query and synonyms of the remaining terms are used as a should match term on a predicate-subject-object triplate.

24. The apparatus according to any of claims 19-23, wherein the extracted text from the natural language processing engine is used as consideration for the documents inclusion into or exclusion from a category.

25. The apparatus according to any of claims 19-24, wherein the circuitry is further configured to perform:
returning a set of documents snippets, wherein the snippets comprise an explicit entity and terms.

26. The apparatus according to claim 25, wherein the return set is evaluated based on matching predicate-subject-object triplet entities.

27. The apparatus according to claims 25 or 26, wherein the snippets comprise a set of documents that best match the entities and terms based on a keyword.

28. An apparatus, comprising:
means for receiving a document at a natural language processing engine, wherein the natural language processing engine extracts text from the document;
means for indexing the extracted text at a data store;
means for mapping a query to an index query to retrieve a response set stored in the natural language processing engine; and
means for mapping the response set to the query, wherein the response is based on the query.

29. The apparatus according to claim 28 further comprising:
means for determining when the query has a curated answer; and
means for providing the curated answer, when the query has a curated answer.

30. The apparatus according to claims 28 or 29 further comprising:
means for determining when the query includes qwords;
means for extracting the qwords by the natural language processing engine, when the query includes qwords; and
means for determining entity types that must be present in the document based on the qwords.

31. The apparatus according to any of claims claim 28-30, wherein the natural processing engine identifies remaining terms in the query and synonyms of the remaining terms are used as a key word constraint in the index query.

32. The apparatus according to any of claims claim 28-31, wherein the natural processing engine identifies remaining terms in the query and synonyms of the remaining terms are used as a should match term on a predicate-subject-object triplate.

33. The apparatus according to any of claims claim 28-32, wherein the extracted text from the natural language processing engine is used as consideration for the documents inclusion into or exclusion from a category.

34. The apparatus according to any of claims claim 28-33 further comprising:
means for returning a set of documents snippets, wherein the snippets comprise an explicit entity and terms.

35. The apparatus according to claim 34, wherein the return set is evaluated based on matching predicate-subject-object triplet entities.

36. The apparatus according to claims 34 or 35, wherein the snippets comprise a set of documents that best match the entities and terms based on a keyword.

37. A non-transitory computer readable medium comprising program instructions stored thereon that when executed in hardware, perform a method comprising:
receiving a document at a natural language processing engine, wherein the natural language processing engine extracts text from the document;
indexing the extracted text at a data store;
mapping a query to an index query to retrieve a response set stored in the natural language processing engine; and
mapping the response set to the query, wherein the response is based on the query.

38. The non-transitory computer readable medium according to claim 37, wherein the method further comprises performing:
determining when the query has a curated answer; and
providing the curated answer, when the query has a curated answer.

39. The non-transitory computer readable medium according to claims 37 or 38, wherein the method further comprises performing:
determining when the query includes qwords;
extracting the qwords by the natural language processing engine, when the query includes qwords; and
determining entity types that must be present in the document based on the qwords.

40. The non-transitory computer readable medium according to any of claims 37-39, wherein the natural processing engine identifies remaining terms in the query and synonyms of the remaining terms are used as a key word constraint in the index query.

41. The non-transitory computer readable medium according to any of claims 37-40, wherein the natural processing engine identifies remaining terms in the query and synonyms of the remaining terms are used as a should match term on a predicate-subject-object triplate.

42. The non-transitory computer readable medium according to any of claims 37-41, wherein the extracted text from the natural language processing engine is used as consideration for the documents inclusion into or exclusion from a category.

43. The non-transitory computer readable medium according to any of claims 37-42, wherein the method further comprises performing:
returning a set of documents snippets, wherein the snippets comprise an explicit entity and terms.

44. The non-transitory computer readable medium according to claim 43, wherein the return set is evaluated based on matching predicate-subject-object triplet entities.

45. The non-transitory computer readable medium according to claims 43 or 44, wherein the snippets comprise a set of documents that best match the entities and terms based on a keyword.
